(19) United States
(12) Patent Application Publication
(10) Pub. No.: US 2020/0264859 A1
(43) Pub. Date: Aug. 20, 2020

(54) System and Method for Tracking Application Data

(71) Applicant: Christopher Jones, Lake Forest Park, WA (US)

(72) Inventors: Christopher Jones, Lake Forest Park, WA (US); Jan Tore Klepp, Burlingame, CA (US); Andreas Lie, Hudiksvall (SE)

(21) Appl. No.: 15/709,416

(22) Filed: Sep. 19, 2017

(51) Int. Cl. G06F 8/61; G06F 16/953; G06F 16/955; H04L 29/08

(52) U.S. Cl. CPC G06F 8/61; G06F 16/953; H04W 4/14; H04L 67/34; H04L 67/02; G06F 16/9558

(57) ABSTRACT

The present disclosure is directed to systems and methods for tracking application data, the method comprising: having a publisher integrate organic install tracking (OIT) code into its website; enabling a visitor to view or click on a link published on the publisher's website or application that links to an application on an application store or on an application download website; passing, via the OIT code, visitor information to an OIT server, the visitor information including impression information, application detail information, visitor click information and visitor device information; determining, with the OIT server, which portions of the visitor information are to be passed to at least one attribution analytics provider (AAP) as attribution data; passing the attribution data to the application's AAP; allowing a user to visit the application store or application download website to download the application, open the application installer and install the application; matching, with the application's AAP, the user with the visitor click information of the visitor information to record the user as a valid install; and posting the valid install as an install confirmation in the OIT server.

### CROSS REFERENCE TO RELATED APPLICATIONS

This application claims the benefit of U.S. Provisional Application Ser. No. 62/363,843, entitled “COMPUTER SOFTWARE ENABLING APP STORES TO DELIVER CLICK INFORMATION TO MOBILE ATTRIBUTION PROVIDERS” and filed on Jul. 19, 2016, the entirety of which is herein incorporated by reference.

### TECHNICAL FIELD

The present disclosure generally relates to systems and methods for tracking application data, or data associated with a software application such as the downloads and installations of that software application, which can be used on any smartphone or computing device, for example.

### BACKGROUND

Many software application developers wish to track downloads and installations of their software applications. Currently, in order to track installations of their applications outside of the Apple and Google app stores or that originate from direct links to a download site, software application developers need to go through cumbersome processes, such as creating separate digital files for different stores or websites where their software application can be downloaded from and tracking multiple links that could change from time to time. Therefore, there is a need for a convenient, efficient and robust way to track application download data such as software application downloads, installs, and shares without having to perform unnecessary work.

### SUMMARY

Provided is a computer-implemented method including: having a publisher integrate organic install tracking (OIT) code into its website; enabling a visitor to view or click on a link published on the publisher's website or application that links to an application on an application store or on an application download website; passing, via the OIT code, visitor information to an OIT server, the visitor information including impression information, application detail information, visitor click information and visitor device information; determining, with the OIT server, which portions of the visitor information are to be passed to at least one attribution analytics provider (AAP) as attribution data; passing the attribution data to the application's AAP; allowing a user to visit the application store or application download website to download the application, open the application installer and install the application; matching, with the application's AAP, the user with the visitor click information of the visitor information to record the user as a valid install; and posting the valid install as an install confirmation in the OIT server.

Provided also is a computer-implemented system that includes an organic install tracking (OIT) server that is configured to receive visitor information about a visitor that views or clicks on a link published by a publisher that links to an application on an application store or on an application download website, the visitor information including impression information, application detail information, visitor click information and visitor device information, the OIT server including: a determination module configured to determine which portions of the visitor information are to be passed to an attribution analytics provider (AAP) as attribution data; and an application including the AAP, wherein the AAP is configured to match a user with the visitor click information of the visitor information to record the user as a valid install.

Also provided is a computer-implemented method including: having a publisher integrate an organic install tracking (OIT) software developer kit (SDK) into its app; enabling a visitor to view or click on a link published on the publisher's app that links to an application on an application store or on an application download website; passing, via the OIT SDK, visitor information to an OIT server, the visitor information including impression information, application detail information, visitor click information and visitor device information; determining, with the OIT server, which portions of the visitor information are to be passed to at least one attribution analytics provider (AAP) as attribution data; passing the attribution data to the application's AAP; allowing a user to visit the application store or application download website to download the application, open the application installer and install the application; matching, with the application's AAP, the user with the visitor click information of the visitor information to record the user as a valid install; and posting the valid install as an install confirmation in the OIT server.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1A is a flowchart of a system and method to track application data, according to an aspect of the present disclosure.

FIG. 1B shows a diagram of various components used for a system to manage reservations, according to an aspect of the present disclosure.

FIG. 2 shows a process flowchart of a method to track application data, according to an aspect of the present disclosure.

FIG. 3 shows a diagram of a system used to track application data, according to an aspect of the present disclosure.

FIG. 4 shows a flow diagram of a user using a method to track application data, according to an aspect of the present disclosure.

FIG. 5 shows a flow diagram of a method to track application data, according to an aspect of the present disclosure.

FIG. 6 shows a screenshot of an analytics attribution provider dashboard, according to an aspect of the present disclosure.

FIG. 7 shows another screenshot of an analytics attribution provider dashboard, according to an aspect of the present disclosure.

FIG. 8 shows yet another screenshot of an analytics attribution provider dashboard, according to an aspect of the present disclosure.

FIG. 9 shows a screenshot of an organic install tracking (OIT) dashboard, according to an aspect of the present disclosure.

FIG. 10 shows a screenshot of a website that has a link to download an application, according to an aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts. As described herein, the use of the term “and/or” is intended to represent an “inclusive OR”, and the use of the term “or” is intended to represent an “exclusive OR”.

The present disclosure is directed to systems and methods of tracking application data, such as information about downloads and installations of software applications or “apps” (e.g. the number of downloads or installations, the location of downloads, the frequency of downloads or installations, the identity information—such as geographical, demographic, consumer behavior data—of users that download or install). Currently, software application developers code, build, develop and create software applications that can be downloaded by users via websites or online stores such as the Apple iTunes store, the Apple App Store, Google Play and others. Such stores or websites are able to monetize the installs of certain software applications occurring as a result of downloads by, for example, posting advertising. However, if software application developers wish to track download or installation data involving their applications that are not directly a result of advertisements (i.e. organic) or that originate in app stores not run by Google or Apple—usually through the recording of visitor information such click information, or data associated with where users click in order to eventually download a software application—they cannot track this information in some cases and in others have to create separate digital files—such as a separate android packet kit (APK or .apk) file or iOS App Store Package (.ipa) file. Furthermore, all application stores have access to a digital file that represents the application, the digital file comprising an APK file or an .ipa file. Furthermore, website publishers and app owners who post links to websites or app stores to download software applications have to do multiple costly integrations in order to support the range of attribution providers used by the apps that they link to from their sites, which can be a burden and bothersome.

The systems and methods of the present disclosure is a significant improvement on current technologies where web publishers and third-party app stores need assistance of the app owner or attribution providers to alter their links in order to effectively deliver click information and monetize their installs. The approach of the present disclosure is the ability to track currently unable to be tracked direct (organic) links and to avoid the use of separate digital files and conveniently use a single digital file to accurately track download and installation data of software applications.

The present disclosure also distinguishes over the current field of art involving tracking application download and installation data. Currently, third party app stores cannot properly deliver click information for attribution purposes unless they have specifically set aside space for ads within their platform. With the advantages provided by the present disclosure, third party app stores are able to deliver, track and record correct and accurate visitor information—which includes application detail information, visitor click information and visitor device information—from anywhere in their stores without any changes to their underlying platform. As a result, the present disclosure is a significant improvement in the sense that it is able to properly deliver visitor information to software developers, app stores, attribution providers, or other interested parties, without having to specifically set aside space for ad campaigns within their platforms and without any changes to the tracking links. This technology has not been compiled or provided in the currently existing prior art. Therefore, the present invention is personally and commercially an advantage over what currently exists in the field.

The present disclosure is also directed to software which enables third party app stores, software developers, attribution providers, website publishers and other parties to properly deliver click information to mobile attribution providers for tracking installs and downloads on mobile devices and tablet devices (e.g. iPad).

In one aspect of the present disclosure, the portal provides a platform to create, manage and assign available campaigns to the service users using the software of the present disclosure. In another aspect of the present disclosure, the public web service method of the software collects all device information that is available to the service user and creates an HTTP loop which redirects until big attribution providers are reached. The software then passes all required values along the click URL together with the campaign and service user identifiers.

The objective of the present disclosure is to deliver click information for attribution providers that is not tied to advertisements without any changes in the underlying platforms of the websites or app stores. A service user issues an HTTP/HTTPS request to the software's web service, passing device identifiers, device information, and the campaign and unique service user. The web service calls the associated tracking URL leading to the application, which results in one or more redirects along the application's tracking networks before ending up at one of the attribution provider web sites. Before making the final call to the attribution provider URL, it is ensured that all information that is required for a valid attribution is passed.

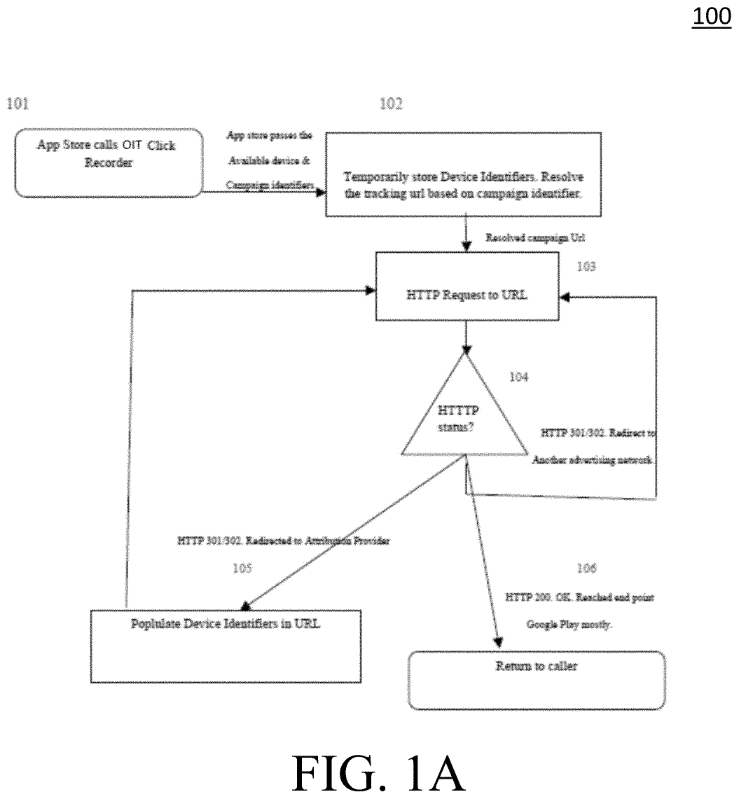

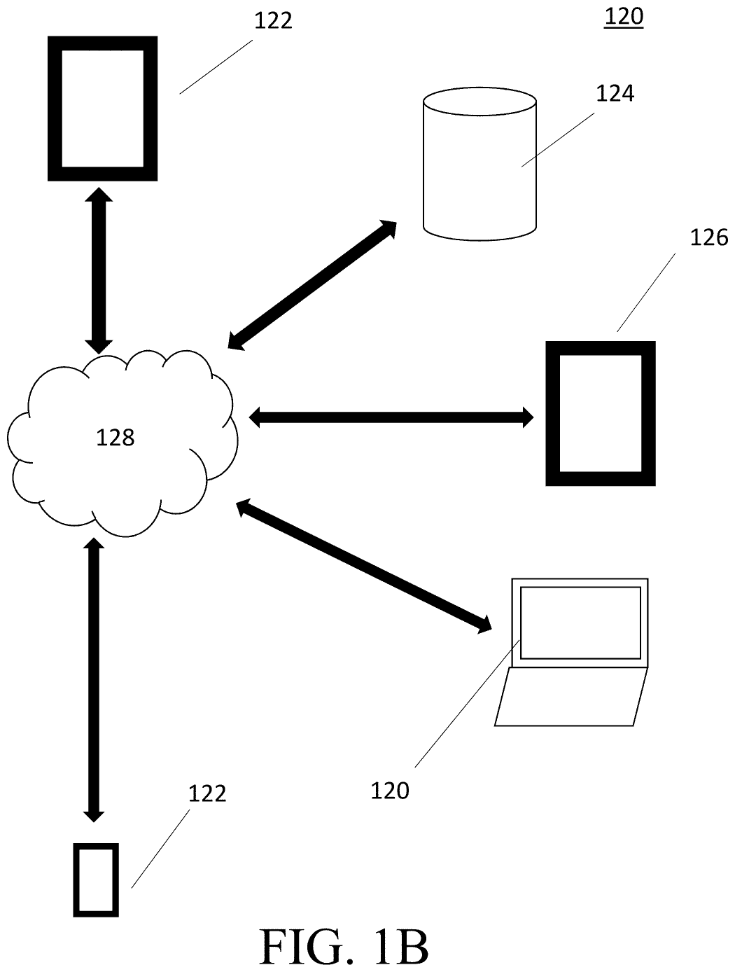

FIG. 1A is a flowchart representation of a public web service method of the software provided by the present disclosure and illustrates how the software collects device information and redirects it in a loop of HTTP and then passes the information to the attribution providers.

Specifically, FIG. 1A relates to the present computer software which enables web and app publishers to monetize via advertisements installs occurring as a result of downloads without app owners needing to create separate digital files (e.g. APK files) or for web and app publishers to have to do costly integrations to support this monetization method. It enables web and app publishers to monetize installs occurring as a result of advertisements on their website or in their apps on a cost per install and/or cost per engagement basis. The flowchart presentation explains the process of the public web service method where it collects the service user information identifying the device and redirects it in a HTTP loop for the attribution providers. The software has the components as described in the following paragraphs.

The computer software is also made up of ‘Administration Panel’ where it creates, manages and assigns available campaigns to the service users. To run a campaign service, user only needs to issue a HTTP or HTTPS Request to the web service, with values that identifies the device, campaign and service user. This is called as ‘Public Web Service Method’ where the software collects all device information that is available to the service user. It executes an HTTP request to the app owner, which results in a loop of HTTP redirects until the software reaches any of the big attribution providers. The process proceeds in the manner where the web publisher or third party App store calls OIT Click Recorder 101 and then the web publisher or app store passes the available device and campaign identifier information temporarily storing device identifiers 102. The web service calls the associated tracking URL leading to the app owner, which results in one or more redirects along tracking networks before ending up at one of the attribution provider web sites 102. HTTP request to URL 103 is done and it redirects to another advertising network 104. The loop redirects and it may either populate device identifiers in URL 105 or it reaches the end point which is a download site or app store (e.g. Google Play or Itunes) mostly 106. After step number 105, the loop is again created for the same process.

FIG. 1B shows a diagram 120 of various components used for a system to track application data, according to an aspect of the present disclosure. Diagram 120 includes a first host app 122, a host application program interface (API) 124, a second host app 126, an internet connection 128, a first user device 120, and a second user device 122. The first host app 122 can be a tablet device, computer, smartphone, computing device or similar device installed with the application using the system to manage reservations used by a software application developer, website publisher, attribution provider, app store or website publisher. For example, the first host app 122 may be used by a software developer interested in tracking downloads and installs of their application. The second host app 126 can also be a tablet device or, smartphone mobile computing device or similar device installed with the application using the system to manage reservations used by another host or restaurant. For example, the second host app 126 may be used by a third party app store (e.g. Google Play). The first user device 120 can be a tablet, smartphone, mobile computing device or similar device installed with the application used to click on a link to download an app by the user. For example, the first user device 120 can be a smartphone connected to the internet 108 and used by a user. The second user device 122 can also be a smartphone, tablet, or similar device used by the user to click on a link to download an app, e.g. by being taken to a app store. For example the second user device 122 can be a smartphone connected to the internet 128 and used by a user. The host API 124 can store code, data or other information used to interface the first host app 122 and the second host app 126 with the first user device 130 and the second user device 132. The first host app 122, the second host app 124, the first user device 130 and the second user device 132 are all coupled, connected to or linked to the internet connection 128, either wirelessly or via a physical wired connection.

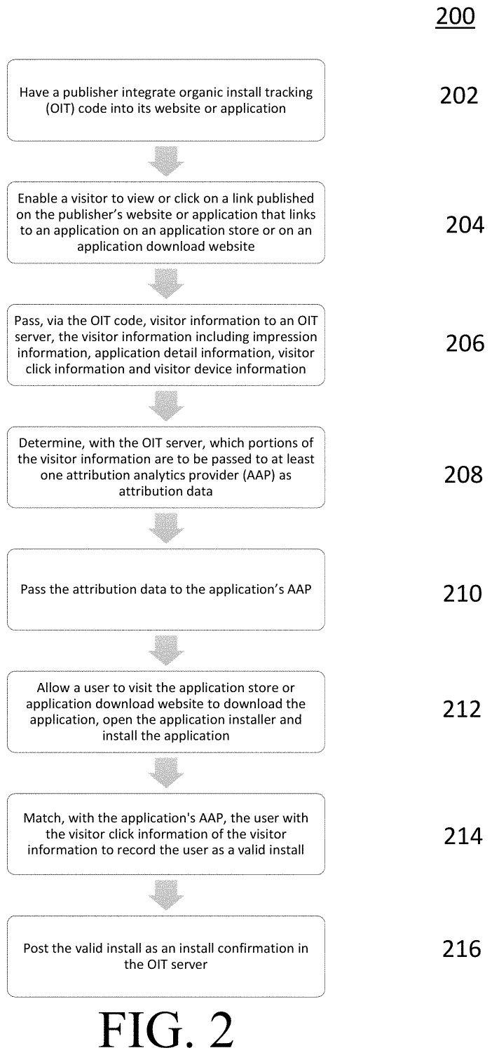

FIG. 2 shows a method 200 including the following steps, which may or may not be performed sequentially. In step 202, have a publisher integrate organic install tracking (OIT) code into its website or application. A publisher can publish an application, a website, an app store, or other type of content. In step 204, enable a visitor to view or click on a link published on the publisher's website or application that links to an application on an application store or on an application download website. In step 206, pass, via the OIT code, visitor information to an OIT server, the visitor information including impression information, application detail information, visitor click information and visitor device information. In step 208, determine, with the OIT server, which portions of the visitor information are to be passed to at least one attribution analytics provider (AAP) as attribution data. In step 210, pass the attribution data to the application's AAP. In one aspect of the present disclosure, AAP is used interchangeably with the term attribution network, and an AAP is an attribution network. In one aspect, an attribution network may work together with an AAP to perform the same consistent function, such as, for example, receive attribution data. In step 212, allow a user to visit the application store or application download website to download the application, open the application installer and install the application. In step 214, match, with the application's AAP (or the application's attribution network), the user with the visitor click information of the visitor information to record the user as a valid install. In step 216, post the valid install as an install confirmation in the OIT server.

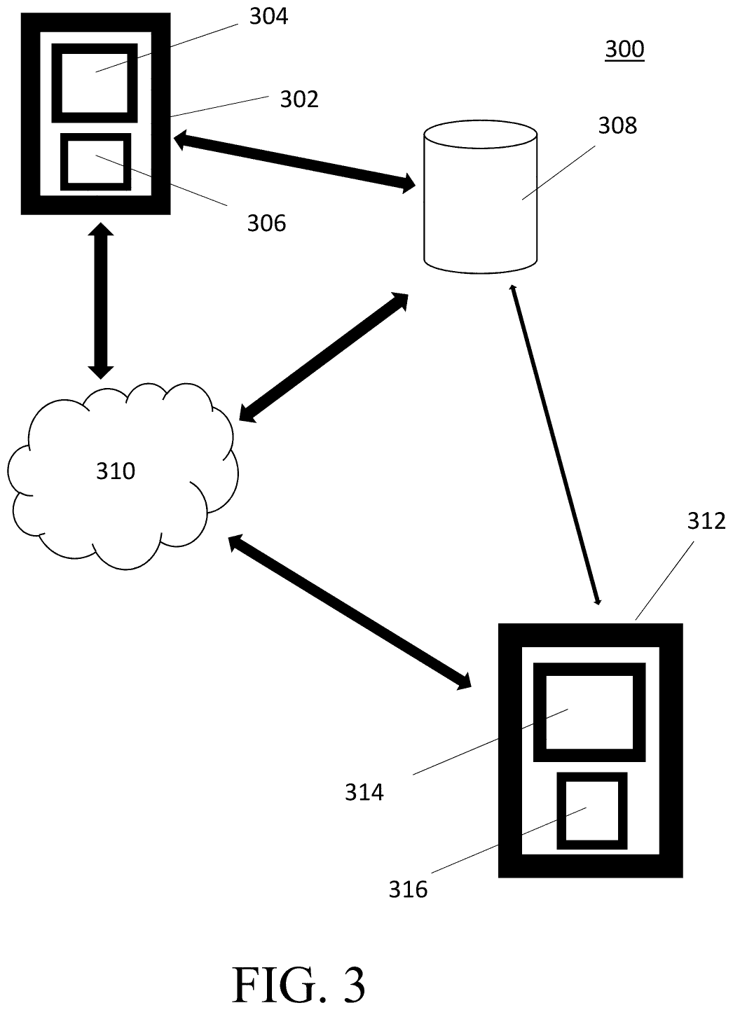

FIG. 3 shows a diagram 300 of a system for tracking application data, according to an aspect of the present disclosure. Diagram 300 includes vendor device 302, which in turn includes a vendor display apparatus 304 and a vendor transmission apparatus 306; and a user device 312, which in turn includes a user display apparatus 314 and a user transmission apparatus 316. The vendor device 302, the reservation data server 308 and the user device 312 are all coupled to the internet 310. A vendor such as a software application developer, attribution provider, web site publisher, third party app store or other party can use the vendor device 302, and a user can use the user device 312. The vendor reception apparatus 306 is configured to transmit and/or receive information such as visitor information pertaining to click information and so on, who again may be using the vendor device 302. The user display apparatus 314 is configured to display on the user device 312 information including the link the user clicks on to download the software application. The user transmission apparatus 316 is configured to receive visitor information (e.g. click information, device information) for the vendor, who may again be using the vendor device 302. The organic install tracking (OIT) server 308 is coupled to both the vendor device 302 and the user device 312. The reservation data 308 is also configured to determine visitor information (e.g. click information) from the vendor device 302, wherein the OIT code server 308 is also configured to track visitor information and other data. The OIT server 308 may also include (not shown) a determination module configured to determine which portions of the visitor information are to be passed to an attribution network as attribution data, an application including an attribution analytics provider, and the attribution network, wherein the attribution network is configured to match a user with the visitor click information of the visitor information to record the user as a valid install.

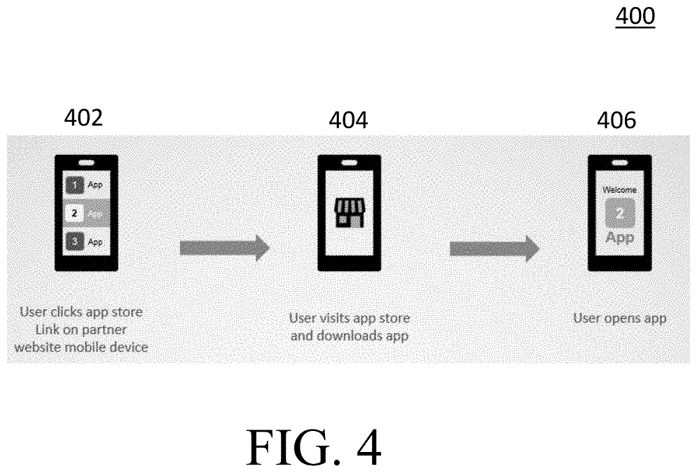

FIG. 4 shows a flow diagram 400 of a user using a method to track application data, according to an aspect of the present disclosure. At event 402, a user, on a mobile device for example clicks a link to an app store on a partner website. At event 404, the user visits the app store (taken there from the link to the app store in event 402) and downloads an app. At event 406, the user opens the app downloaded in event 404.

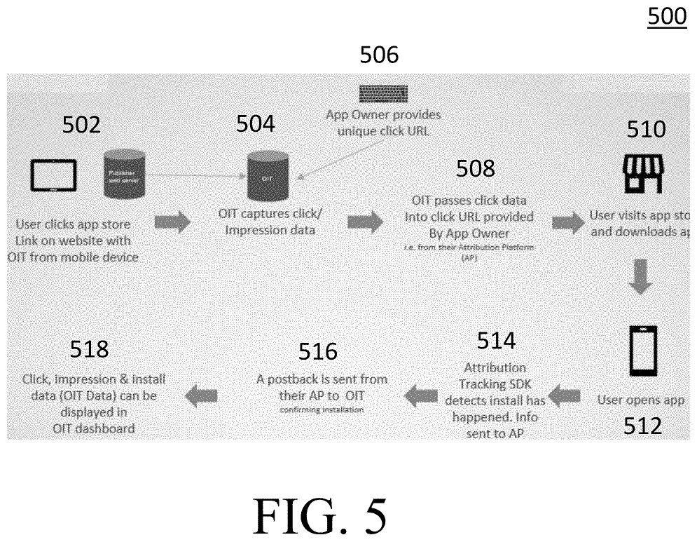

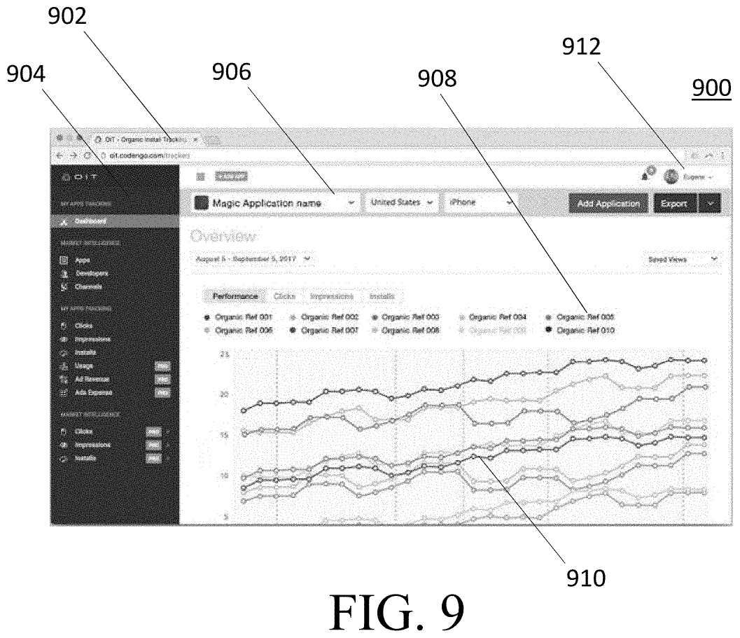

FIG. 5 shows a flow diagram 500 of a method to track application data, according to an aspect of the present disclosure. The method shown in flow diagram 500 may also happen in the background when the method shown in flow diagram 400 of FIG. 4 executes. At event 502, a user, on a mobile device for example (or any other type of computer) clicks a link to an app store on a website connected to the organic install tracking (OIT) system of the present disclosure. At event 504, the OIT system captures click and impression data and may also store that data in a database. At event 506, an app owner (or owner/developer of an app) provides an unique click URL to the OIT system. At event 508, the OIT system passes click data into a click URL provided by the app owner. In one aspect, the OIT system can pass click data into the click URL provided by the app owner from the app owner's attribution platform (AP). At event 510, the user visits an app store (via the mobile phone, smart phone or any other type of computer) and downloads an app from the app owner. At event 512, the user opens the app that was downloaded from event 510. At event 514, an attribution tracking software developer kit (SDK) detects that an install has happened. Information about this install is sent to the app owner's AP. At event 516, a post back (or message or post) is sent from the app owner's AP to the OIT system, thereby confirming installation. At event 518, click, impression and install data (collectively referred to as the OIT data) can be displayed on an OIT dashboard, as shown in greater detail in FIG. 9.

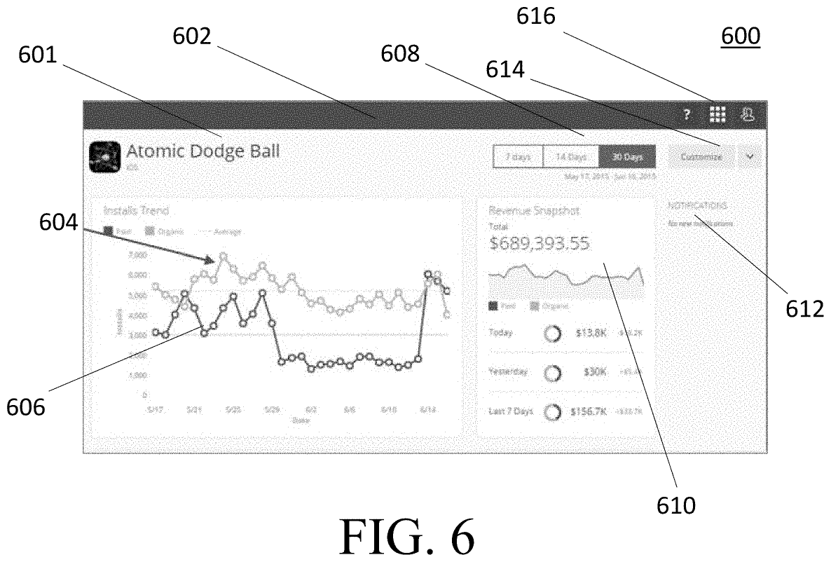

FIG. 6 shows a screenshot 600 of an analytics attribution provider (AAP) dashboard 602, according to an aspect of the present disclosure. Examples of APP can include, for example, Tune, Kochava, AppsFlyer, Adjust and other software programs that track the installation data for application downloads. AAP dashboard 602 includes application name 601, organic line graph 604, paid line graph 606, time indicator 608, revenue snapshot panel 610, notifications panel 612, customize bar 614, and upper icons 616. Organic line graph 604 shows or plots the number of organic app installs of the application or app identified by application name 601 as a function of time. Paid line graph 606 shows or plots the number of paid-for app installs of the application or app identified by application name 601 as a function of time. With mobile-phone or smartphone based attribution, a paid-for app install is usually attributable while an organic app install is not attributable. However, with the OIT system of the present disclosure, more installs will be attributable than what is currently available to app owners in prior art AAPs or application installation data tracking systems that currently exist. The organic line graph 604, after implementation of the OIT system of the present disclosure, will show data that reduces the number of unknown (e.g. organic) installs of the app referred to by application name 601 and in doing so enable the app developer or app owner to obtain greater insights into advertising for users, or customizing advertising for optimal app downloads of, for example, the app shown by application name 601. Time indicator 608 allows the user currently using or viewing the AAP to customize the amount of time that the organic line graph 604 and the paid line graph 606 are plotted for. The revenue snapshot panel 610 shows data such as total revenue from paid installs of the app identified by application name 601, a plot of revenue from paid installs over a specified time period, revenue from previous day, current day or last 7 day installs and other data that is not limited to the metrics that are shown. Notifications panel 612 shows a panel where notifications relevant to the AAP or AAP dashboard 602 can appear. Customize bar 614 can be used to customize the appearance of the AAP dashboard 602 or individual panels within the AAP dashboard 602 such as the notifications panel 612 or the revenue snapshot panel 610, for example. Upper icons 616 can include icons that control the functionality of the AAP dashboard 602 such as, for example shown, whether to display data in a grid-like fashion, a help button that links to a help functionality (either live support or the user is taken to a help file) or the ability to modify user settings from a user profile. However, the buttons that can be included in the upper icons 616 is not limited to the buttons that are shown.

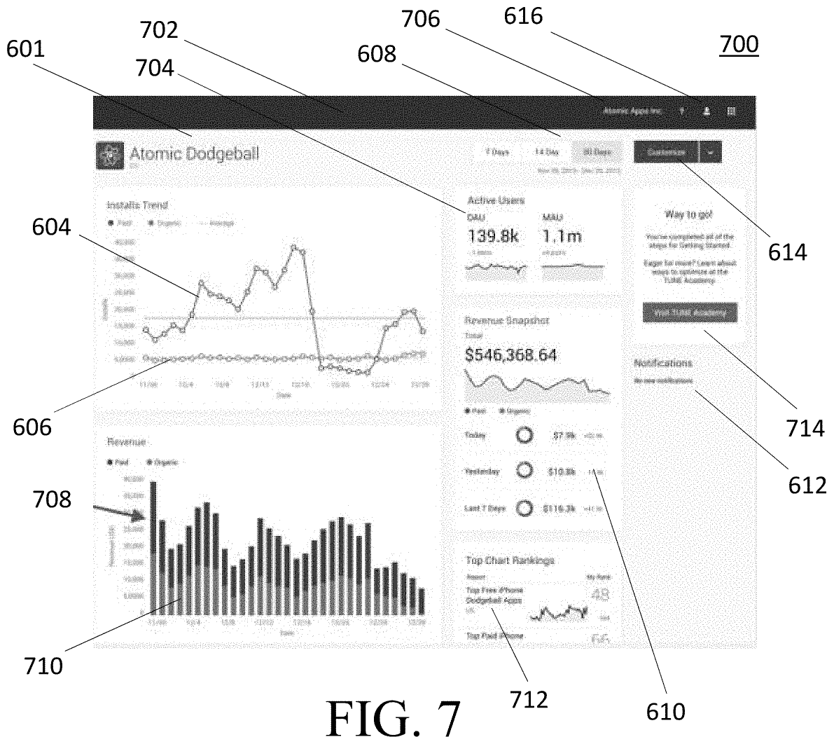

FIG. 7 shows another screenshot 700 of an AAP dashboard 702, according to an aspect of the present disclosure. AAP dashboard 702 includes the already above-described elements of the application name 601, the organic line graph 604, the paid line graph 606, the time indicator 608, the revenue snapshot panel 610, the notifications panel 612, the customize bar 614, and the upper icons 616. However, AAP dashboard 702 also includes the new elements of active user panel 704, app developer ID 706, paid bar graph 708, organic bar graph 710, top chart rankings panel 712 and further instruction panel 714. Active user panel 704 may provide information about active users of a particular app identified by the application name 601. App developer ID 706 displays the ID or name of the app developer or app owner of the application named by application name 601 being analyze by the AAP dashboard 702. Paid bar graph 708 plots revenue of paid-for installs of the application or app identified by application name 601 as a function of time. Organic bar graph 710 plots revenue of organic installs of the application or app identified by application name 601 as a function of time. Top chart rankings panel 712 can display information such as top free downloaded apps of a certain device (such as an iPhone or Android) or top paid downloaded apps of a certain device, or the rank of a particular app owner identified by the app developer ID 706 or the rank of the app identified by application name 601 and other data not limited to the data that is shown. Further instruction panel 714 may also appear when the user of the AAP panel 702 completes all tutorials or educational modules about the AAP system and can be taken to an academy or website of further online learning tools in order to learn more about the functionality of the AAP system and to improve their skills in using the AAP system. The OIT system of the present disclosure will enable greater insights such as being able to examine revenue by channel for organic installs (e.g. via the organic bar graph 710) which is currently unavailable in the prior art or current application installation data tracing systems. Even if such a capability is available in the prior art, it is only available for a limited number of channels and parameters. The OIT system of the present disclosure will enable the monitoring of information (e.g. via the organic bar graph 710) for organic installs for many more channels and parameters.

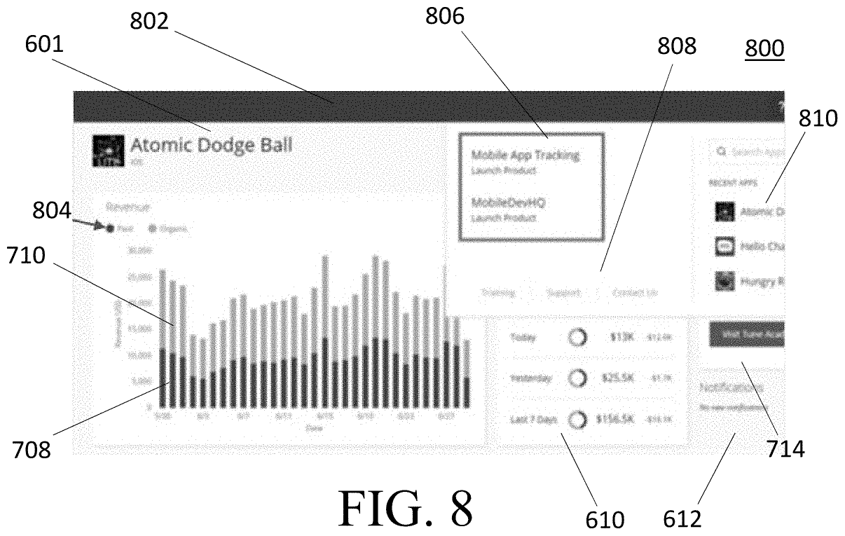

FIG. 8 shows yet another screenshot 800 of an AAP dashboard 802, according to an aspect of the present disclosure. AAP dashboard 802 includes the already above-described elements of the application name 601, the organic bar graph 710, the paid bar graph 708, part of the revenue snapshot panel 610, part of the notifications panel 612, and part of the further instruction panel 714. However, AAP dashboard 802 includes the new elements of revenue selector 804, mobile window 806, mobile window options 808, and app selector 810. Revenue selector 804 allows the AAP to change labels from attributed to not attributed and vice versa, as more of the organic installs become attributable due to the implementation of the OIT system of the present disclosure. Mobile window 804 can be a pop-up window that provides information such as mobile app tracking for the app identified by application name 601, or a link to the mobile app development headquarters or company, even though the mobile window 804 is not limited to the functions or links shown. Mobile window options 808 also pop-up along with the mobile window 804 and can allow a user of the AAP to undergo further training, contact support or contact the administrator of the AAP or the company that makes the AAP. However, the mobile window options 808 are not limited to the options that are currently shown. App selector 810 also allows the user of the AAP to select another app to analyze by the AAP dashboard 802, the current app being analyzed shown or identified by the application name 601.

FIG. 9 shows a screenshot 900 of an organic install tracking (OIT) dashboard 902, according to an aspect of the present disclosure. The OIT dashboard 902 includes a side panel 904, a current application selector 906, an organic install identifier 908, an organic install plot 910 and an OIT system user ID 912. The side panel 904 has various options that can be utilized in an OIT system, such as the OIT system of the present disclosure, such as (but not limited to) as shown: finding more information about different apps, developers, channels and seeing more metrics on clicks, impressions, installs, usage, ad reveue, ad expenses and other data. Current application selector 906 configures the OIT dashboard 902 to display data (such as the plots 910) for a particular app or application, e.g. identified by the “Magic application name”, “United States” and “iPhone” as shown in FIG. 9. Organic install identifier 908 is an identifier such as a color or pattern that identifies a particular type of organic installation pattern, scheme, type or other category of organic installs for the app identified by the information in the current application selector 906. Organic install plot 910 is a line plot of the organic installation pattern, scheme, type or other category specified by the organic install identifier 908 as a function of time. OIT system user ID identifies the user of the OIT system and the OIT dashboard 902 and displays information relevant to that user (e.g. name, profile picture, notifications) and allows the user to change settings about the OIT system or OIT dashboard 902, or their own user settings, by clicking on the user's name or profile picture.

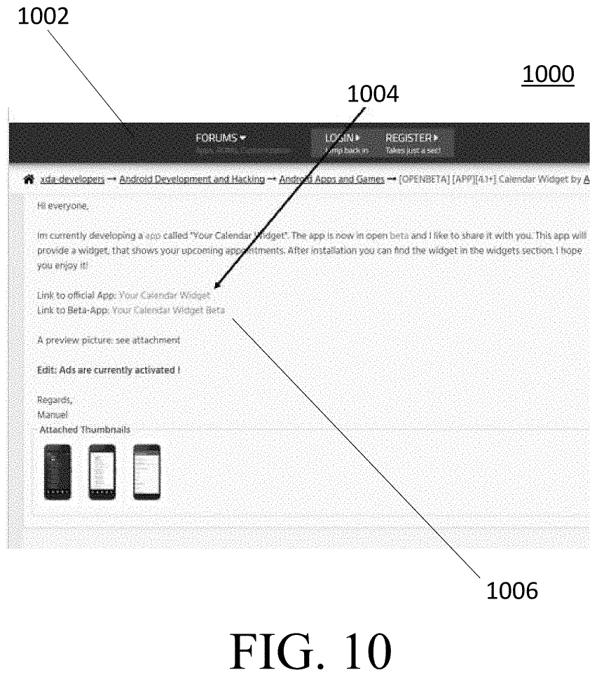

FIG. 10 shows a screenshot 1000 of a website 1002 that has a link to download an application, according to an aspect of the present disclosure. Website 1002 has an official app link 1004 and a beta app link 1006. Official app link 1004 is the type of link that is currently not attributed that the OIT system of the present disclosure would make attributable. For example, official app link 1004 would link to an official app store such as Google's Play Store or Apple's App Store—which would make the download or install information not attributable or lost in the clicking process. However, with the OIT system of the present disclosure, links such as official app link 1004 that link to official app stores will become attributable and trackable. Beta app links 1006 may be more easily attributable or trackable because they may take the user directly to the app owner's website or store. However, if any direction or information from the beta app link 1006 becomes lost in the process or non-attributable, the OIT system of the present disclosure will remedy that and make such data (e.g. click, attribution or install data) attributable and trackable.

According to an aspect of the present disclosure, a first path or method or process is provided including the following steps, which may or may not happen sequentially. In a first step, a web or mobile publisher integrates organic install tracking (OIT) code, into their web site, for example. Also, the OIT code may be integrated into a web site via a link to an app store, such as “http://appstore.com/app/xapp” where “appstore” is the URL or name of a fictional app store and “xapp” is the name of a fictional app. In a second step, the web publisher or user of the web publisher's site publishes a link to an app on an app store or download site. In a third step, visitors to the site view the link or click on the link. In a fourth step, the OIT code passes impression and/or click information and device information to an OIT server. In a fifth step, the OIT server analyzes information needed to pass to the attribution network utilized by an attribution analytics provider (AAP). In a sixth step, click information, app details and device information is passed to an app's AAP. In a seventh step, visitors go to an app store or download site, download the app, and then open the app, which counts as an install of the app. In an eighth step, the app owner's AAP matches the visitor's click information with their converted user information to record the new user as a valid install. In a ninth step, the install and/or other engagement confirmation is posted back to the OIT server or another OIT database working with or accessible by the OIT server. In a tenth step, the click, install and attribution data is displayed in an OIT dashboard. In an eleventh step, the click, install and attribution data is passed to a developer attribution tracking dashboard. This eleventh step may be optional.

According to an aspect of the present disclosure, a second path or method or process is provided including the following steps, which may or may not happen sequentially. In a first step, a web or mobile publisher or user of the web publisher's site publishes a link (or tracking link) to an app on an app store or download site using an OIT URL shortcut such as “http://oit.ly/xapp” where “oit.ly” is a fictional URL shortening address and “xapp” is the name of a fictional app. In a second step, visitors to the site click on the link. In a third step, the link passes click information and device information to an OIT server. In a fourth step, the OIT server analyzes information needed to pass to the attribution network utilized by an attribution analytics provider (AAP). In a fifth step, click information, app details and device information is passed to an app's AAP. In a sixth step, visitors go to an app store or download site, download the app, and then open the app, which counts as an install of the app. In a seventh step, the app owner's AAP matches the visitor's click information with their converted user information to record the new user as a valid install. In an eighth step, the install and/or other engagement confirmation is posted back to the OIT server or another OIT database working with or accessible by the OIT server. In a ninth step, the click, install and attribution data is displayed in an OIT dashboard. In a tenth step, the click, install and attribution data is passed to a developer attribution tracking dashboard. This tenth step may be optional.

According to an aspect of the present disclosure, a third path or method or process is provided including the following steps, which may or may not happen sequentially. In a first step, an app publisher or app developer integrates or installs an organic install tracking (OIT) software development kit (SDK) in an app. In a second step, the app publisher or user of an app publisher's app publishes a link to an app on an app store or download site. In a third step, users of the app view the link or click on the link. In a fourth step, the OIT SDK or code within the OIT SDK or OIT code within the OIT SDK asses impression and/or click information and device information to an OIT server. In a fifth step, the OIT server analyzes information needed to pass to the attribution network utilized by an attribution analytics provider (AAP). In a sixth step, click information, app details and device information is passed to an app's AAP. In a seventh step, visitors go to an app store or download site, download the app, and then open the app, which counts as an install of the app. In an eighth step, the app owner's AAP or the attribution network of the app owner's AAP matches the visitor's click information with their converted user information to record the new user as a valid install. In a ninth step, the install confirmation is posted back to the OIT server or another OIT database working with or accessible by the OIT server.

The present disclosure is directed to a computer software which enables web publishers and third party app stores to track installs occurring as a result of downloads originating from the publisher's sites or apps without app owners needing to create separate APK files for the stores or for attribution providers to have to change their tracking links. This HTTP web service has a public method that takes all device information that is available to the user of the service. It then passes all required values along the click URL together with the campaign and service user identifiers. Before making the final call to the attribution provider URL, it is ensured that all information that is required for an attribution without involving a third-party app store is passed.

In one aspect of the present disclosure, provided is a computer-implemented method including: having a web publisher integrate organic install tracking (OIT) code into its website or an app owner into its app; enabling a visitor to view or click on a link published on the web publisher's website that links to an application on an application store or on an application download website; passing, via the OIT code, visitor information to an OIT server, the visitor information including impression information, application detail information, visitor click information and visitor device information; determining, with the OIT server, which portions of the visitor information are to be passed to an attribution network as attribution data; passing the attribution data to the application's attribution analytics provider; allowing a user to visit the application store or application download website to download the application, open the application installer and install the application; matching, with the attribution network, the user with the visitor click information of the visitor information to record the user as a valid install; and posting the valid install as an install confirmation in the OIT server.

In one aspect and in the above-described method, the install confirmation and the attribution data to a developer attribution tracking dashboard.

In one aspect and in the above-described method, the link is published on an affiliate website associated with the web publisher's website or in an application associated with the publisher.

In one aspect and in the above-described method, the visitor information passed to the OIT server includes application detail information, visitor click information and visitor device information.

In one aspect and in the above-described method, the website published by the web publisher includes a website accessible via a mobile phone, mobile phone content, short message service (SMS) message and a multimedia messaging service (MMS) message.

In one aspect and in the above-described method, the attribution network is adaptable to any new form of an attribution network in the future.

In one aspect and in the above-described method, the website is searched for at least one link to an application store, and further wherein the impression information is checked against the at least one link to an application store.

In one aspect and in the above-described method, all the different application stores have access to a digital file that represents the application, the digital file comprising an android packet kit (APK) file or an IOS application .ipa (iOS App Store Package) file.

In one aspect and in the above-described method, information coming from the website is treated the same regardless if the source is a website, a mobile website, or an application.

In one aspect, provided also is a computer-implemented system that includes an organic install tracking (OIT) server that is configured to receive visitor information about a visitor that views or clicks on a link published on a web publisher's website or in an app publisher's app that links to an application on an application store or on an application download website, the visitor information including impression information, application detail information, visitor click information and visitor device information, the OIT server including: a determination module configured to determine which portions of the visitor information are to be passed to an attribution network as attribution data; an application including an attribution analytics provider; and the attribution network, wherein the attribution network is configured to match a user with the visitor click information of the visitor information to record the user as a valid install.

In one aspect and in the above-described system, OIT code is integrated into the web publisher's website or app publisher's application.

In one aspect and in the above-described system, the OIT server includes an installation poster module which is configured to post the valid install as an install confirmation within the OIT server.

In one aspect and in the above-described system, the OIT server includes a dashboard passing module which is configured to pass the visitor information, the install confirmation and the attribution data to a developer attribution tracking dashboard.

In one aspect and in the above-described system, the link is published on an affiliate website associated with the web publisher's website or app publisher's application.

In one aspect and in the above-described system, the website published by the web publisher includes a website accessible via a mobile phone, mobile phone content, short message service (SMS) message and a multimedia messaging service (MMS) message.

In one aspect and in the above-described system, the attribution network is adaptable to any new form of an attribution network in the future.

In one aspect and in the above-described system, the website is searched for at least one link to an application store, and further wherein the impression information is checked against the at least one link to an application store.

In one aspect and in the above-described system, all the different application stores have access to a digital file that represents the application, the digital file comprising an android packet kit (APK) file or an IOS application .ipa (iOS App Store Package) file.

In one aspect and in the above-described system, information coming from the website is treated the same regardless if the source is a website, a mobile website, or a page from an application.

In one aspect, provided is also a computer-implemented method comprising: enabling a visitor to view or click on a link published on the web publisher's website or app publisher's application that links to an application on an application store or on an application download website; passing, via the link, visitor information to an organic install tracking (OIT) server, the visitor information including impression information, application detail information, visitor click information and visitor device information; determining, with the OIT server, which portions of the visitor information are to be passed to an attribution network as attribution data; passing the attribution data to the application's attribution analytics provider; allowing a user to visit the application store or application download website to download the application, open the application installer and install the application; matching, with the attribution network, the user with the visitor click information of the visitor information to record the user as a valid install; posting the valid install as an install confirmation in the OIT server; and passing the visitor information, the install confirmation and the attribution data to a developer attribution tracking dashboard.

In one aspect of the present disclosure, a computer-implemented method is provided for tracking application installs, the method including: having a publisher integrate organic install tracking (OIT) code into its website or application; enabling a visitor to view or click on a link published on the publisher's website or application that links to an application on an application store or on an application download website; passing, via the OIT code, visitor information to an OIT server, the visitor information including impression information, application detail information, visitor click information and visitor device information; determining, with the OIT server, which portions of the visitor information are to be passed to at least one attribution analytics provider (AAP) as attribution data; passing the attribution data to the application's AAP; allowing a user to visit the application store or application download website to download the application, open the application installer and install the application; matching, with the application's AAP, the user with the visitor click information of the visitor information to record the user as a valid install; and posting the valid install as an install confirmation in the OIT server.

In one aspect, the above-described method further includes passing the visitor information, the install confirmation and the attribution data to a AAP dashboard so that it can be seen, the AAP dashboard being modified by the OIT code to reflect the specific sources of data.

In one aspect, the above-described method further includes passing the visitor information, the install confirmation and the attribution data to a OIT dashboard so it can be viewed directly.

In one aspect, in the above-described method, the link is published on an affiliate website is associated with a website owned by the publisher.

In one aspect, in the above-described method, the visitor information passed to the OIT server only includes application detail information, visitor click information and visitor device information.

In one aspect, in the above-described method, the publisher can publish an app, a website and an app store that is accessible via a mobile phone, mobile phone content, short message service (SMS) message and a multimedia messaging service (MMS) message.

In one aspect, in the above-described method, the AAP is adaptable and information can be passed to any new form of an AAP developed in the future.

In one aspect, in the above-described method, the website is searched for at least one link to an application store, and further wherein the impression information is checked against the at least one link to an application store.

In one aspect, in the above-described method, all the different application stores have access to a digital file that represents the application, the digital file comprising an android packet kit (.apk) file.

In one aspect, in the above-described method, the information coming from the website is treated the same regardless if the source is a website, a mobile website, or a page from an application store.

In one aspect of the present disclosure, a computer-implemented system for tracking application installs is provided, the system including:

an organic install tracking (OIT) server that is configured to receive visitor information about a visitor that views or clicks on a link published by a publisher that links to an application on an application store or on an application download website, the visitor information including impression information, application detail information, visitor click information and visitor device information, the OIT server including: a determination module configured to determine which portions of the visitor information are to be passed to an attribution analytics provider (AAP) as attribution data; and an application including the AAP, wherein the AAP is configured to match a user with the visitor click information of the visitor information to record the user as a valid install.

In one aspect, in the above-described system, the OIT code is integrated into a website owned by the publisher.

In one aspect, in the above-described system, the OIT server includes an installation poster module which is configured to post the valid install as an install confirmation within the OIT server.

In one aspect, in the above-described system, the OIT server includes a dashboard passing module which is configured to pass the visitor information, the install confirmation and the attribution data to a dashboard, the dashboard comprising an AAP dashboard and an OIT dashboard

In one aspect, in the above-described system, the link is published on an affiliate website associated with a website owned by the publisher.

In one aspect, in the above-described system, the publisher can publish an app, a website and an app store that is accessible via a mobile phone, mobile phone content, short message service (SMS) message and a multimedia messaging service (MMS) message.

In one aspect, in the above-described system, the AAP is adaptable and information can be passed to any new form of an AAP developed in the future.

In one aspect, in the above-described system, the website is searched for at least one link to an application store, and further wherein the impression information is checked against the at least one link to an application store.

In one aspect, in the above-described system, the different application stores have access to a digital file that represents the application, the digital file comprising an android packet kit (.apk) file or .ipa (iOS App Store Package) file.

In one aspect of the present disclosure, a computer-implemented method is provided for tracking application installs, the method including: having a publisher integrate an organic install tracking (OIT) software developer kit (SDK) into its app; enabling a visitor to view or click on a link published on the publisher's app that links to an application on an application store or on an application download website; passing, via the OIT SDK, visitor information to an OIT server, the visitor information including impression information, application detail information, visitor click information and visitor device information; determining, with the OIT server, which portions of the visitor information are to be passed to at least one attribution analytics provider (AAP) as attribution data; passing the attribution data to the application's AAP; allowing a user to visit the application store or application download website to download the application, open the application installer and install the application; matching, with the application's AAP, the user with the visitor click information of the visitor information to record the user as a valid install; and posting the valid install as an install confirmation in the OIT server.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

For a firmware and/or software implementation, the methodologies may be implemented with modules (e.g., procedures, functions, and so on) that perform the functions described herein. A machine-readable medium tangibly embodying instructions may be used in implementing the methodologies described herein. For example, software codes may be stored in a memory and executed by a processor unit. Memory may be implemented within the processor unit or external to the processor unit. As used herein, the term “memory” refers to types of long term, short term, volatile, nonvolatile, or other memory and is not to be limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include RAM, ROM, EEPROM, CD-ROM or other optical disk storage, magnetic disk storage or other magnetic storage devices, or other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above and below may refer to sides of a substrate or electronic device. Moreover, the scope of the present application is not intended to be limited to the particular configurations of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

What is claimed is:

1. A computer-implemented method for tracking application installs, the method comprising:
having a publisher integrate organic install tracking (OIT) code into its website or application;
enabling a visitor to view or click on a link published on the publisher's website or application that links to an application on an application store or on an application download website;
passing, via the OIT code, visitor information to an OIT server, the visitor information including impression information, application detail information, visitor click information and visitor device information;
determining, with the OIT server, which portions of the visitor information are to be passed to at least one attribution analytics provider (AAP) as attribution data;
passing the attribution data to the application's AAP;
allowing a user to visit the application store or application download website to download the application, open the application installer and install the application;
matching, with the application's AAP, the user with the visitor click information of the visitor information to record the user as a valid install; and
posting the valid install as an install confirmation in the OIT server.

2. The computer-implemented method of claim 1, further comprising passing the visitor information, the install confirmation and the attribution data to a AAP dashboard so that it can be seen, the AAP dashboard being modified by the OIT code to reflect the specific sources of data.

3. The computer-implemented method of claim 1, further comprising passing the visitor information, the install confirmation and the attribution data to a OIT dashboard so it can be viewed directly.

4. The computer-implemented method of claim 1, wherein the link is published on an affiliate website is associated with a website owned by the publisher.

5. The computer-implemented method of claim 1, wherein the visitor information passed to the OIT server only includes application detail information, visitor click information and visitor device information.

6. The computer-implemented method of claim 1, wherein the publisher can publish an app, a website and an app store that is accessible via a mobile phone, mobile phone content, short message service (SMS) message and a multimedia messaging service (MMS) message.

7. The computer-implemented method of claim 1, wherein the AAP is adaptable and information can be passed to any new form of an AAP developed in the future.

8. The computer-implemented method of claim 1, wherein the website is searched for at least one link to an application store, and further wherein the impression information is checked against the at least one link to an application store.

9. The computer-implemented method of claim 1, wherein all the different application stores have access to a digital file that represents the application, the digital file comprising an android packet kit (.apk) file.

10. The computer-implemented method of claim 1, wherein information coming from the website is treated the same regardless if the source is a website, a mobile website, or a page from an application store.

11. A computer-implemented system for tracking application installs, comprising:
an organic install tracking (OIT) server that is configured to receive visitor information about a visitor that views or clicks on a link published by a publisher that links to an application on an application store or on an application download website, the visitor information including impression information, application detail information, visitor click information and visitor device information, the OIT server including:
a determination module configured to determine which portions of the visitor information are to be passed to an attribution analytics provider (AAP) as attribution data; and
an application including the AAP, wherein the AAP is configured to match a user with the visitor click information of the visitor information to record the user as a valid install.

12. The computer-implemented system of claim 11, wherein OIT code is integrated into a website owned by the publisher.

13. The computer-implemented system of claim 11, wherein the OIT server includes an installation poster module which is configured to post the valid install as an install confirmation within the OIT server.

14. The computer-implemented system of claim 13, wherein the OIT server includes a dashboard passing module which is configured to pass the visitor information, the install confirmation and the attribution data to a dashboard, the dashboard comprising an AAP dashboard and an OIT dashboard

15. The computer-implemented system of claim 11, wherein the link is published on an affiliate website associated with a website owned by the publisher.

16. The computer-implemented system of claim 11, wherein the publisher can publish an app, a website and an app store that is accessible via a mobile phone, mobile phone content, short message service (SMS) message and a multimedia messaging service (MMS) message.

17. The computer-implemented system of claim 11, wherein the AAP is adaptable and information can be passed to any new form of an AAP developed in the future.

18. The computer-implemented system of claim 11, wherein the website is searched for at least one link to an application store, and further wherein the impression information is checked against the at least one link to an application store.

19. The computer-implemented system of claim 11, wherein all the different application stores have access to a digital file that represents the application, the digital file comprising an android packet kit (.apk) file or .ipa (iOS App Store Package) file.

20. A computer-implemented method for tracking application installs, the method comprising:
having a publisher integrate an organic install tracking (OIT) software developer kit (SDK) into its app;
enabling a visitor to view or click on a link published on the publisher's app that links to an application on an application store or on an application download website;
passing, via the OIT SDK, visitor information to an OIT server, the visitor information including impression information, application detail information, visitor click information and visitor device information;
determining, with the OIT server, which portions of the visitor information are to be passed to at least one attribution analytics provider (AAP) as attribution data;
passing the attribution data to the application's AAP;
allowing a user to visit the application store or application download website to download the application, open the application installer and install the application;
matching, with the application's AAP, the user with the visitor click information of the visitor information to record the user as a valid install; and
posting the valid install as an install confirmation in the OIT server.
